(19) United States
(12) Patent Application Publication
(10) Pub. No.: US 2009/0007067 A1
(43) Pub. Date: Jan. 1, 2009

(54) COMPOSITE PORTAL APPLICATION

(75) Inventors: Stefan Hepper, Holzgerlingen (DE); Walter Haenel, Holzgerlingen (DE); Stefan Liesche, Boeblingen (DE); Michael Marks, Kirchheim-Teck (DE); Andreas Nagel, Stuttgart (DE); Thomas Stober, Boeblingen (DE)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 12/143,558

(22) Filed: Jun. 20, 2008

(30) Foreign Application Priority Data
Jun. 28, 2007 (EP) 07111260.1

(51) Int. Cl. G06F 9/44

(52) U.S. Cl. 717/115; 717/114

(57) ABSTRACT

The invention relates to a method of providing a composite portal application for a portal server application environment. In accordance with an embodiment of the invention, the method comprises:
providing application components in machine readable code for forming the portal application;
providing an application assembly descriptor in machine readable code, wherein the application assembly descriptor comprises meta-data, wherein the meta-data specifies how the application components have to be assembled to provide the composite portal application on the portal server application environment;
providing a set of functions;
using the functions of the set of functions as points of variability in the meta-data, wherein the functions are adapted to be evaluated by the portal server application environment.

### FIELD OF THE INVENTION

The invention relates to a method of providing a composite portal application for a portal server application environment. The invention also relates to a portal server application environment and to a data processing system adapted to host the portal server application environment.

### BACKGROUND

Composite portal applications are also known as portal server applications. Composite portal applications provide a flexible framework to produce very complex websites with reasonable effort. The basic functional units of a composite portal application are so called application components that are also known as portlets. Portlets can be considered as building bricks to create a complex composite portal application. The portal application aggregates the output of the individual portlets to an output which can be rendered in a browser. This aggregation of content is a key feature of composite portal applications, since it integrates the user interface (UI) of independent portlets nicely without the need to write any integration code.

Modern composite portal applications comprise more than just a couple of application components. Further components can be added to produce even more sophisticated J2EE applications. The term J2EE is an acronym for Java Platform, Enterprise Edition which provides a programming platform for developing and running distributed multi-tier architecture Java applications.

A complex vertical J2EE application comprises manifold base J2EE component types as well as many portal specific component types, which are all suited together to a coherent composite portal application produced by a large application development team.

The document US 2006/0036993 A1 describes a system and method for developing composite portal applications and for automatically deploying portal applications into a portal server application. According to an embodiment of the method in accordance with the above mentioned document, a composite portal application is provided to a portal server application environment as a portal application archive which includes all application components in machine-readable code for forming the portal application, and an application assembly descriptor in machine readable code which specifies how the application components need to be assembled to provide the portal application on the portal server environment. In order to deploy the composite portal application into the portal server application environment, the portal application archive is provided to a deployment mechanism within the portal server application environment which is able to deploy the portal application archive into the portal server environment. Further, the application assembly descriptor included in the portal application archive is evaluated by means of the deployment mechanism, and the application components are automatically deployed into respective parts of the portal server application environment according to information included in the application assembly descriptor.

The application assembly descriptor can be implemented in form of an XML descriptor file. The application assembly descriptor comprises meta-data that describe and that can be evaluated by the above mentioned deployment mechanism in order to determine how each particular application component of the composite portal application has to be used within the portal application. The meta-data provided by the application assembly descriptor therefore provides essential added value for the composite application with respect to the standard Java J2EE. While Java only supports coding, deployment and life cycle aspects of composite portal applications, the meta-data can be regarded as comprising the logic focus description language on top of Java and might therefore be implemented in form of XML.

The meta-data in the application assembly descriptor can comprise some points of variability, meaning that they comprise some degrees of freedom, which have to be specified during instantiation of the composite portal application by the end-user or portal administrator at instantiation time of the composite portal application.

It is an object of the invention to use these points of variability in order to increase the flexibility of the meta-data provided by the application assembly descriptor.

### SUMMARY OF THE INVENTION

According to a first aspect of the invention, there is provided a method of providing a composite portal application for a portal server application environment. In accordance with an embodiment of the invention, the method comprises the step of providing application components in machine readable code for forming the portal application. Further, an application assembly descriptor is provided in machine readable code. The application assembly descriptor comprises meta-data. The meta-data specifies how the application components have to be assembled to provide the composite portal application on the portal server application environment. Furthermore, a set of functions is provided. The functions of the set of functions are used as points of variability in the meta-data and adapted to be evaluated by the portal server application environment.

The portal server application environment can be regarded as the runtime environment which is used to deploy the composite portal application and which evaluates the functions of the set of functions either during instantiation of the composite portal application or during runtime of the composite portal application.

For example, instead of using a parameter as a point of variability in the meta-data, a function might be used. This provides the advantage that the portal server application environment can directly evaluate the function so that the user or administrator of the composite portal application does not have to provide a parameter or specification for the point of variability in the meta-data. Due to the usage of the function, the parameter can be provided directly by the portal server application environment.

In accordance with an embodiment of the invention, the set of functions comprises at least one function.

In accordance with an embodiment of the invention, a function of the set of functions is adapted to be associated with a parameter during instantiation of the composite portal application. The user or portal administrator is then requested to provide the parameter during instantiation of the composite portal application. The function can therefore be used as a replacement of a static parameter in the corresponding point of variability in the meta-data in a way that the user or administrator of the portal application is requested to provide the corresponding parameter for the point of variability.

In accordance with an embodiment of the invention, the parameter is set in a further application. The further application is one of the application components provided for the composite portal application in machine readable code or an external application which is not provided for the composite portal application. Thus, the parameter or more precisely the input value for the function can be specified via a parameter which is given by another application so that no specifications must be provided by the user or administrator of the portal application during instantiation of the portal application in the runtime environment. This improves the convenience of the user of the portal application as the user must not anymore specify the parameters during the instantiation of the portal application.

In accordance with an embodiment of the invention, an external reference is used to reflect a function of the set of functions in the meta-data. A parameter management logic is then provided for the composite portal application which is executable by the portal server application environment. The parameter management logic is then employed by the portal server application environment to determine the function via the corresponding external reference during the runtime or during instantiation of the portal application.

The function reflected by the external reference itself must therefore not be implemented directly into the meta-data of the application assembly descriptor. The function can for example be referenced by use of the corresponding external reference. The parameter management logic is then used to determine the function via the corresponding external reference during runtime of the portal application and to actively set a specific value for the input parameters of the function.

In accordance with an embodiment of the invention, an agent is provided for the composite portal application which is executable by the portal server application environment. Further, the agent is used to monitor the behavior of users of the portal application. This allows for a determination of usage patterns of the users, wherein a function of the set of functions is adapted to return parameter values according to the usage pattern of the actual user of the composite portal application, for instance, when that portal application gets instantiated for this user.

By looking at the usage patterns of users, the agent can for example find out that users who are associated with the role of a developer will probably choose the value ‘design.doc’ as the category name for a portlet of the composite portal application. After a new corporate design has been published, the agent will notice that most users are changing the value for the parameter ‘background color’ and either automatically change the value for the composite portal application or at least propose to change the background color to the user of the composite portal application.

In accordance with an embodiment of the invention, an external service outside of the composite portal application is provided. A function of the set of functions is used as point of variability in the meta-data, wherein the function is used to link an application component of the application components with the external service.

A point of variability in the meta-data can therefore be associated with the function which provides a link to the external service. This allows using the functionality provided by external services via the corresponding function for the composite portal application even if the external service is not a component of the composite portal application.

A part of the meta-data which is used to define interactions between application components of the composite portal application or, in accordance with the invention, in order to define and to achieve an interaction between an application component and an external service can be regarded as a wire. A wire provides a linkage between references and services provided by the application component and the external service. The function which is integrated into the meta-data of the application assembly descriptor and which provides the link to the external service can then be regarded as the interface within the wire that actually provides the linkage to the external service. The method in accordance with the invention is therefore particularly advantageous as by the usage of functions in the meta-data external services can be linked to the composite portal application whenever appropriate.

In accordance with an embodiment of the invention, the external service relates to a service component architecture (SCA) component and a function of the set of functions provides an interface to the SCA component. SCA components do not play well in the composite application infrastructure when directly integrated thereto, for example as an application component for the composite portal application. The function of the set of functions which provides the link to the SCA component is particularly advantageous as it can be regarded as an interface between the ‘SCA world’ and the ‘composite application world’ and therefore allows using the functionalities and services provided by an SCA component via the composite portal application.

In accordance with an embodiment of the invention, a function of the set of functions is associated with a service discovery mechanism, wherein the service discovery mechanism is adapted to discover the external service during runtime of the portal application. During runtime of the composite portal application, the service discovery mechanism provided for the composite portal application and executed by the portal server application environment can try to detect an external service which is specified in a generic way in the function. For example, the function might specify that an email service is needed and the service discovery mechanism scans then the data processing system hosting the portal server application environment for an appropriate email program which gets then linked automatically to the composite portal application. The method in accordance with the invention is therefore particularly advantageous as it allows integrating services that are actually available on the data processing system executing and hosting the portal application into the composite portal application in a dynamical way.

In accordance with an embodiment of the invention, the functions of the set of functions are script-based or based on a programming language. The functions can for example be provided in form of a JavaScript or in Pearl or based on a programming language like Java.

In accordance with an embodiment of the invention, the application assembly descriptor is an XML file. The term XML is within this document used as acronym for extensible mark-up language.

In accordance with an embodiment of the invention, the meta-data of the application assembly descriptor is specified in XML.

In accordance with an embodiment of the invention, the functions of the set of functions are one of the following: a mathematical function adapted to receive one or more input values and to output an output value, an access path to a data file stored on the data processing system or on the network hosting the composite portal application, a URI (uniform resource identifier).

The method in accordance with the invention is particularly advantageous as it enables to embed and to make use of points of variability in the meta-data. This furthermore allows for linking information between individual components in a dynamic and portal specific way. The points of variability can be not just properties that are exchanged between components of an application but might relate to functions that allow for the determination of specific values during instantiation time or runtime. The functions allow for using functionalities or services provided by other components within the portal application or by external services such as web services or SOA/SCA Service and therefore allow for combining composite applications and their components with a service oriented architecture (SOA).

According to a second aspect of the invention, there is provided a computer program product which comprises a computer usable medium including computer usable program code. The computer program product is employable to deploy a composite portal application. The composite portal application comprises application components in machine readable code for forming the portal application, an application assembly descriptor in machine readable code, wherein a set of functions is further provided, and wherein the application assembly descriptor comprises meta-data. The computer usable program code is adapted to employ the meta-data to assemble the application components in order to provide the composite portal application on the portal server application environment. The computer usable program code is further adapted to evaluate a function of the set of functions when the function is employed as point of variability for the meta-data.

According to a third aspect of the invention, there is provided a method for automatically deploying a composite portal application into a portal server application environment, wherein the portal application is provided to the portal server application environment as a portal application archive which includes all application components in machine readable code for forming the portal application, and an application assembly descriptor in machine readable code which specifies how the application component needs to be assembled to provide the portal application on the portal server environment.

In accordance with an embodiment of the invention, the method comprises the steps of providing the portal application archive to a deployment mechanism within the portal server application environment which is able to deploy the portal application archive into the portal server environment, evaluating the application assembly descriptor included in the portal application archive by means of the deployment mechanism, and automatically deploying the application components into respective parts of the portal server application environment according to information included in the application assembly descriptor, wherein the application assembly descriptor employs as points of variability in the meta-data a set of functions, and wherein the deployment mechanism of the portal server application environment is adapted to evaluate the functions of the set of functions function.

In accordance with an embodiment of the invention, the application assembly descriptor uses a function of the set of functions to link an application component of the application components with an external service which is provided external to the composite portal application. The deployment mechanism is adapted to evaluate the function and thereby to provide the link with the application component and the external service.

According to a fourth aspect of the invention, there is provided a portal server application environment. The portal server application environment is adapted to execute a composite portal application. The composite portal application includes application components in machine readable code for forming the portal application, an application assembly descriptor in machine readable code. The application assembly descriptor comprises meta-data and the portal server application environment comprises means for employing the meta-data to assemble the application components for the provision of the composite portal application on the portal server application environment. The portal server application environment also comprises means for evaluating a function of a set of functions, when the function is employed as point of variability in the meta-data.

In accordance with an embodiment of the invention, the composite portal application is provided to the portal server application environment as a portal application archives Furthermore, the portal server application environment comprises a deployment mechanism which is adapted to deploy the portal application archive into the portal server environment.

In accordance with a fifth aspect of the invention, there is provided a data processing system which is adapted to host a portal server application environment in accordance with the invention.

In accordance with an embodiment of the invention, the data processing system is adapted to host the external service and the portal server application environment.

### BRIEF DESCRIPTION OF THE DRAWINGS

In the following embodiments of the invention will be described in greater detail by way of example only making reference to the drawings in which:

FIG. 1 shows a block diagram of a data processing system hosting a composite portal application,

FIG. 2 shows a flow diagram illustrating steps of a method in accordance with the invention,

FIG. 3 shows a block diagram of a data processing system hosting a composite portal application and a SCA component,

FIG. 4 shows examples of fragments of meta-data comprised in the application assembly descriptor,

FIG. 5 shows an example of a portlet made visible to a user of the composite application, wherein the portlet is used to request the user to specify parameter values to parameters or to link formulas to the parameters,

FIG. 6 shows examples of fragments of meta-data comprised in the application assembly descriptor,

FIG. 7 shows a table giving a quick overview how functions as point of variability in meta-data of application components can be advantageously employed by a portal server application environment.

### DETAILED DESCRIPTION

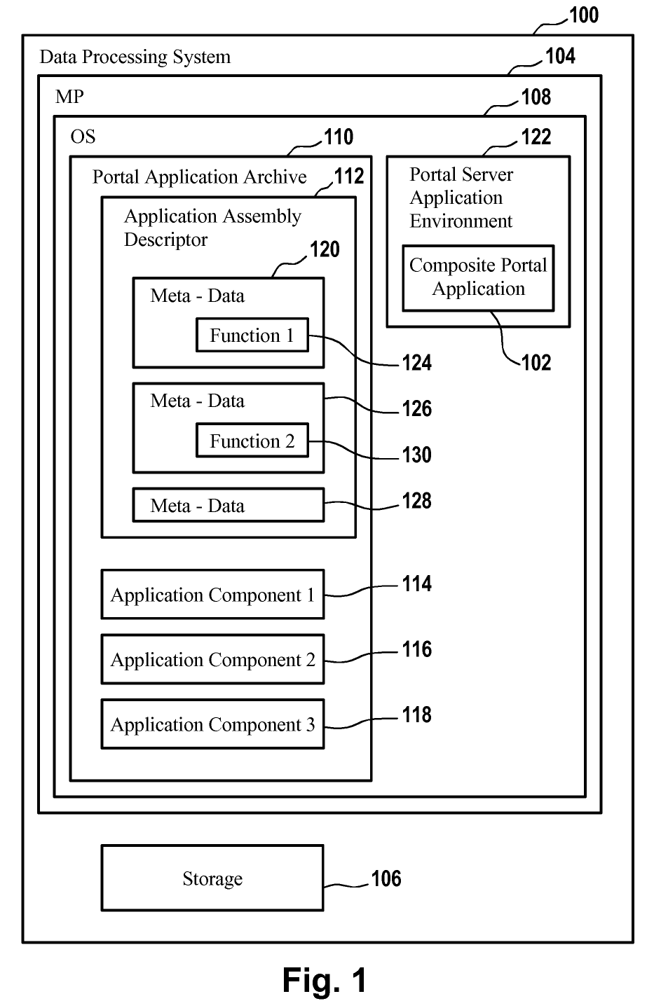

FIG. 1 shows a block diagram of a data processing system 100 hosting a composite portal application 102. The data processing system 100 comprises a microprocessor 104 and storage 106. The microprocessor 104 executes an operating system 108. The code of the operating system 108 is permanently stored on the storage 106 and loaded for execution into the microprocessor 104. A portal application archive 110 is provided to the operating system 108. The operating system 108 also executes a portal server application environment 122 which serves as runtime engine for the composite portal application 102.

The code of the portal application archive 110 and of the portal server application environment 122 might also be stored on the storage 106 from where they are loaded for execution into the microprocessor 104.

The composite portal application 102 is deployed into the portal server application environment 122 by use of the portal application archive 110. The portal application archive 110 comprises an application assembly descriptor 112 and the application components 114, 116, and 118.

The application assembly descriptor 112 comprises meta-data 120, meta-data 126, and meta-data 128. The meta-data 120 specify how the application component 114 is to be used in the composite portal application 112 when provided to a portal server application environment 122 that is used to deploy the composite portal application 102. The meta-data 126 specify how the application component 116 is to be used in the composite portal application 112 when provided to the portal server application environment 122 that is used to deploy the composite portal application 102. The meta-data 128 specify how the application component 118 is to be used in the composite portal application 112 when provided to the portal server application environment 122 that is used to deploy the composite portal application 102.

The meta-data 120, 126, and 128 can for example describe business logic information for the application components 114, 116, and 118, respectively, layout of pages and portlets referring to the application components 114, 116, and 118, configuration information for the application components 114, 116, and 118, and so on. The meta-data 120, 126, and 128 therefore allow for the generation of the composite portal application 102 from the application components 114, 116, and 118 by assembling these components to a meaningful logic. The meta-data 120, 126, 128 therefore specify the topology of the composite portal application 102. The meta-data 120, 126, 128 include some ‘points of variability’ that might be filled in with parameters or with functions. In particular, the meta-data 120 comprises a first function 124 as point of variability and the meta-data 126 comprises a second function 130 as point of variability.

The first function 124 and the second function 130 can be interpreted by the portal server application environment 122 during the instantiation of the composite portal application 102 or during the execution of the composite portal application 102 within the runtime environment provided by the portal server application environment 122. The first and second functions 124, 130 can be defined indirectly in the meta-data 120 and 126, respectively, by the developer of the application assembly descriptor 112. The first function 124 and/or the second function 130 might further have an input value or several input values that are requested from the user of the composite portal application 102 during instantiation of the composite portal application 102 or these input parameters might be specified in other applications, for example in one of the application components 114 to 118. This provides the advantage that the user of the composite portal application 120 does not have to specify a parameter for the corresponding input values as they are already delivered within the portal application archive 110.

As mentioned above, the meta-data 120 specify how to use the application component 114. The first function 124 can therefore be employed as an interface for the application component 114. The meta-data 126 specify how to employ the application component 116 and the second function 130 can therefore be adapted to represent an interface of the application component 116. The interfaces provided by the first and second functions 124 and 130 for the application components 114 and 116 might then be used in order to link or to wire the application components 114 and 116 with each other so that one of the application components might be able to employ the functionality of the other application component.

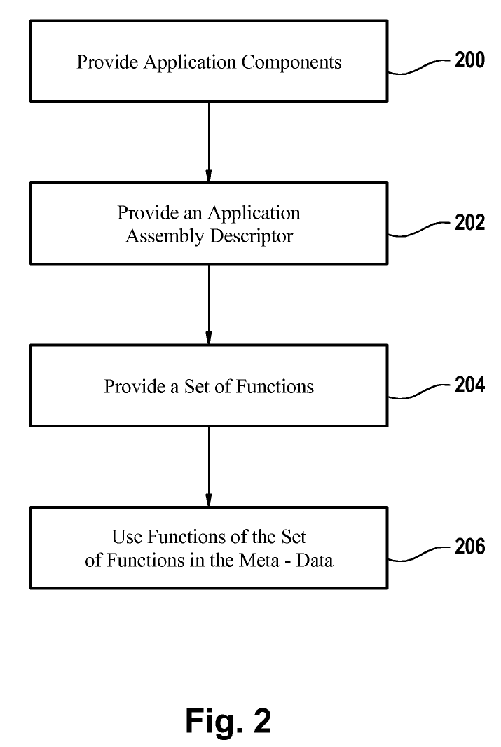

FIG. 2 shows a flow diagram illustrating steps of a method of providing a composite portal application for a portal server application environment in accordance with the invention. According to step 200 of the method in accordance with the invention, application components are provided in machine readable code for forming the portal application. According to step 202, an application assembly descriptor is provided in machine readable code. The application assembly descriptor comprises meta-data. The meta-data specifies how the application components have to be assembled to provide the composite portal application on the portal server application environment. Furthermore, according to step 204 of the method in accordance with the invention, a set of functions is provided. According to step 206, the functions of the set of functions are employed as points of variability in the meta-data, wherein the functions are adapted to be evaluated by the portal server application environment during instantiation of the composite portal application or during the runtime of the composite portal application.

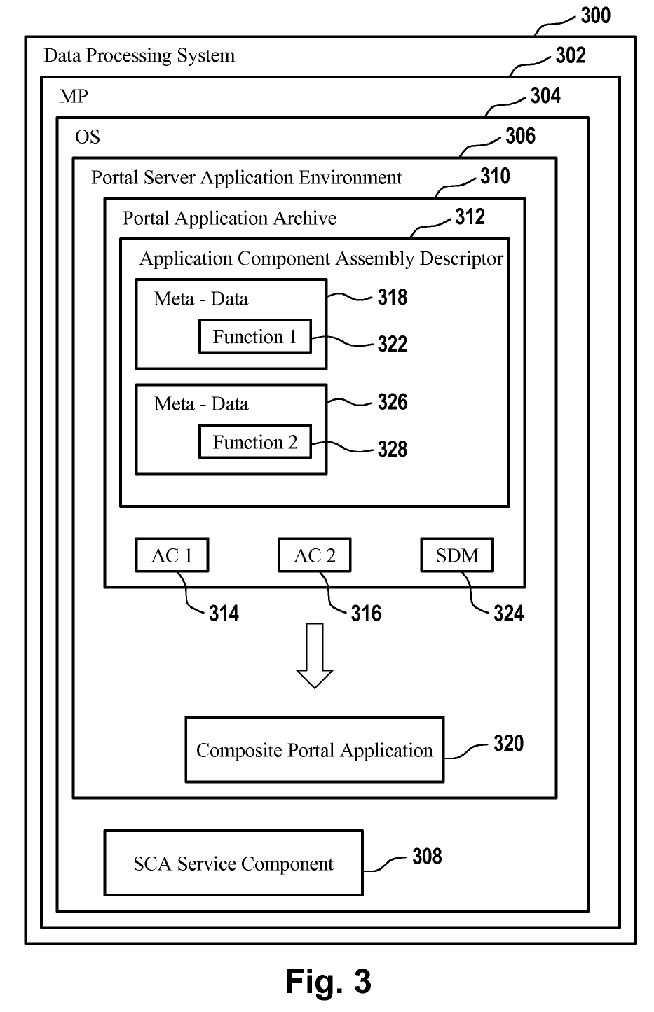

FIG. 3 shows a block diagram of a data processing system 300 having a microprocessor 302 which executes an operating system 304. The operating system 304 hosts a portal server application environment 306 which can be regarded as a runtime engine for a composite portal application 320.

The operating system 304 also hosts a SCA service component 308. SCA is an acronym for service component architecture which is a relatively new but important initiative advocated by major vendors of Java EE technology. SCA service components have however currently the disadvantage that they do not work well within a composite portal application.

A portal application archive 310 is provided to the portal server application environment 306. The portal application archive 310 comprises an application assembly descriptor 312 and application components 314 and 316. The application assembly descriptor 312 comprises meta-data 318 and meta-data 326 which are used to specify how the application components 314 and 316 have to be assembled by the portal server environment to provide the composite portal application 320. In particular, the meta-data 318 specify how application component 314 must be assembled by the portal server environment, and the meta-data 326 specify how application component 314 must be assembled.

In detail, the portal application archive is provided to a deployment mechanism (not shown in FIG. 3 for simplicity reasons) within the portal server application environment 306. The deployment mechanism is able to deploy the portal application archive 310 in the portal server application environment 306. The deployment mechanism then evaluates the meta-data 318, 326 of the application assembly descriptor 312. The application components 314 and 316 are then automatically deployed into respective parts of the portal server application environment 306 according to information included in the meta-data 318, 326 so that the composite portal application 320 is generated. The application assembly descriptor 312 or more precisely the meta-data 318, 326 therefore includes base schema definitions, topology schema definitions and security schema definitions and the portal application archive is provided as a Java EAR file.

As mentioned before, the meta-data 318 and 326 also comprise some points of variability which can be specified by parameter values or by functions. According to the example described here, a first function 322 is comprised in the meta-data 318 which is used to link a service provided for example by the application component 314 with another service provided by the SCA service component 308.

The application component 314 might for example relate to an email editor portlet which allows a user of the composite portal application 320 to write and to edit an email, for example on a user interface made visible to the user via a screen which is connected to the data processing system 300 or part of the data processing system 300. The SCA service component 308 might for example relate to an email delivery service and might therefore provide a component by which emails can be sent to other parties. The first function 322 is then employed in order to wire the email editor portlet provided by the application component 314 with the email delivery service provided by the SCA service component 308 so that a user of the composite portal application 320 is not only able to write and edit an email but also to directly send the email to a third party. The method in accordance with the invention is therefore particular advantageous as by using functions within the meta-data links to external services, such as the SCA service component, can be provided. This contributes to an increase of the amount of services that can be provided to users of composite portal applications.

The first function 322 can be even specified in a generic way. Thus, the first function 322 might only require that according to the example given above, an email delivery service shall be linked with the email editor portlet provided by the application component 314. In this case, the portal application archive comprises a service discovery mechanism 324. The service discovery mechanism 324 can be provided by an extra application component as indicated in FIG. 3. The service discovery mechanism 324 comprises machine readable computer code which is adapted to enable the portal server application environment 306 to search for the corresponding service as specified in the first function 322 and to discover the corresponding service specified in the first function 322 and then to adapt the meta-data 318 in a way so that the first function 322 provides an actual link to the discovered external service.

A second function 328 is further comprises in the meta-data 326. The second function 328 serves as point of variability in the meta-data 326 of the application component 316 and can for example be evaluated during runtime or during instantiation of the composite portal application 320.

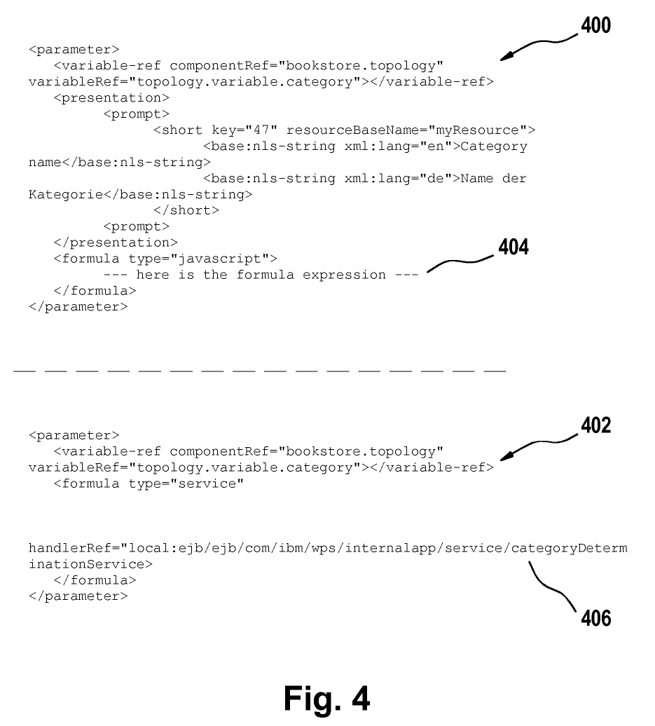

FIG. 4 shows examples of fragments of meta-data 400 and 402 that are comprised in the application assembly descriptor. The fragment 400 and the fragment 402 are implemented in form of XML. The fragment of meta-data 400 shows an example how a category name provided by an application component ‘bookstore’ can be specified by use of a function 404 which can be directly integrated by use of a formula expression via JavaScript into the XML code. For simplicity reasons, any details of the formula expression are not shown.

The fragment of meta-data 402 illustrates how the meta-data can be used to specify a service in the application component ‘bookstore’ by use of a function which is not directly reflected in the template, but associated with an identifier 406. According to the example shown here, the identifier 406 relates to a location on the corresponding data processing system where specifications for the service can be found. As mentioned before, a parameter management logic can be employed to interpret the identifier 406 and set the specific values according to the identifier 406 and the function referenced by the identifier 406.

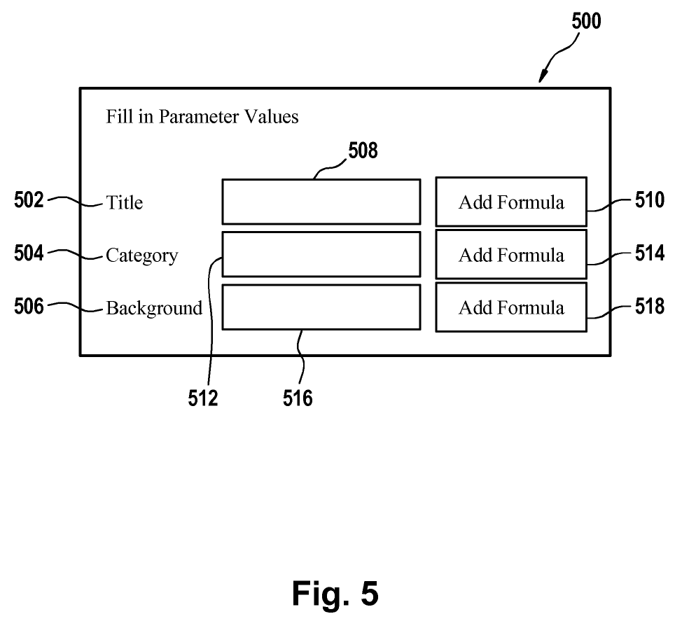

FIG. 5 shows an example of a portlet 500. The portlet 500 can be related to the example of the bookstore for which fragments of meta-data have been shown in FIG. 4. The portlet 500 is used to request from a user of the bookstore portlet within the composite application a title 502, a category 504, and background information 506 for a book that is to be sold, for example via another application component of the composite portal application. By use of the portlet 500, the user of the composite application is requested to specify in the blank field 508 the book title or alternatively to link the title 502 with a formula expression 5 10. Similarly, the user is requested to specify a parameter for the category 504 in the blank field 512 or to link the category 504 with a formula 514. The background information 506 must also be provided by a user in the blank field 516 or the user must associate the background information 506 with a formula expression 518.

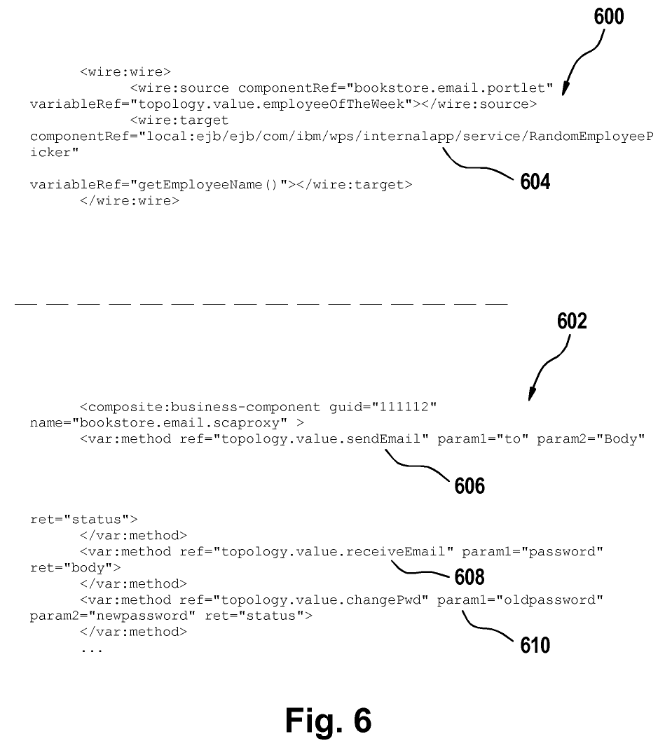

FIG. 6 shows examples of fragments of meta-data 600 and 602. The meta-data can be implemented in the application assembly descriptor. The fragments of meta-data 600 and 602 are specified in form of XML code.

The fragment of meta-data 600 is used for an application component which exposes a user interface in order to edit emails to a user. In the meta-data, a component export variable is referenced to a function 604 that links the email portlet to an external service which might provide the functionality of sending emails.

The fragment of meta-data 602 is used to declare functions 606, 608, and 610 that represent interfaces to external SCA services. The functions refer in this case to methods that specify within the XML codes how the referenced SCA services have to be addressed.

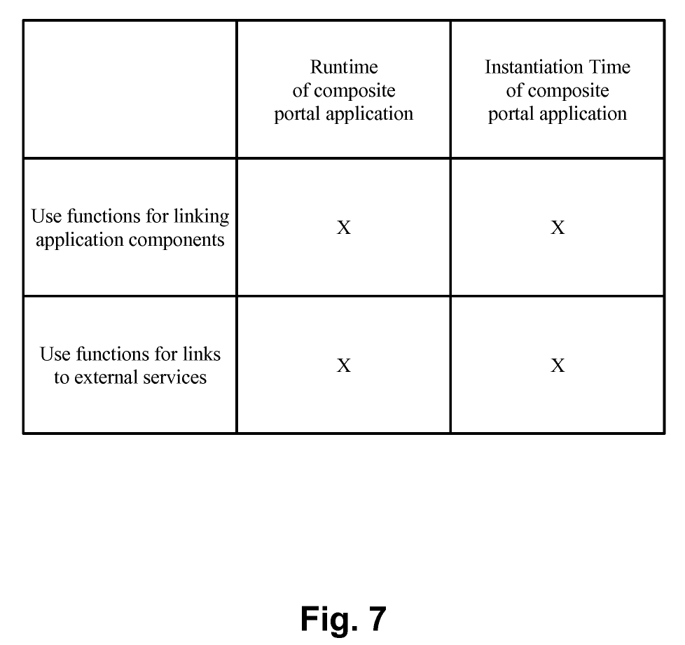

FIG. 7 shows a table giving a quick overview how functions as points of variability in meta-data of application components can be advantageously employed by a portal server application environment. The portal server application can employ the functions in the meta-data for linking application components of which a composite portal application is built with each other in a dynamically way during runtime or instantiation time of the portal server application as indicated by the second line of the table and as indicated by the crosses (X). Functions in the meta-data can further be employed for linking application components to external services like SCA services, either during runtime or during instantiation time of the corresponding composite portal application as indicated by the last line of the table and as indicated by the crosses (X).

### LIST OF REFERENCE NUMERALS

100 Data processing system

102 Composite portal application

104 Microprocessor

106 Storage

108 Operating system

110 Portal application archive

112 Application assembly descriptor

114 Application component

116 Application component

118 Application component

120 Meta-data

122 Portal server application environment

124 First function

126 Meta-data

128 Meta-data

130 Second function

300 Data processing system

302 Microprocessor

304 Operating system

306 Portal server application environment

308 SCA service component

310 Portal application archive

312 Application assembly descriptor

314 Application component

316 Application component

318 Meta-data

320 Composite portal application

322 First function

324 Service discovery module

326 Meta-data

328 Second function

400 Fragment of meta-data

402 Fragment of meta-data

404 Function

406 Function

500 Portlet

502 Title

504 Category

506 Background information

508 Blank field

510 Formula expression

512 Blank field

514 Formula expression

516 Blank filed

518 Formula expression

600 Fragment of meta-data

602 Fragment of meta-data

604 Function

606 Function

608 Function

610 Function

1. A method of providing a composite portal application (102) for a portal server application environment (122), the method comprising:
providing application components (114, 116, 118) in machine readable code for forming the portal application;
providing an application assembly descriptor (112) in machine-readable code, the application assembly descriptor comprising meta-data (120, 126, 128), the meta-data specifying how the application components have to be assembled to provide the composite portal application on the portal server application environment;
providing a set of functions (124, 130);
using the functions of the set of functions as points of variability in the meta-data, the functions being adapted to be evaluated by the portal server application environment.

2. The method of claim 1, wherein a function of the set of functions (124) is adapted to be associated with a parameter during instantiation of the composite portal application, wherein the parameter is to be provided by an user of the portal application or wherein the parameter is set in a further application, the further application being one of the application components (114, 116, 118) or an external application (308).

3. The method of claim 1, wherein an external reference (406) is used to reflect a function of the set of functions in the meta-data, the method further comprising:
providing a parameter management logic which is executable by the portal server application environment;
employing the parameter management logic to determine the function via the external reference during runtime of the portal application.

4. The method of claim 1, further comprising:
providing an agent which is executable by the portal server application environment;
using the agent to monitor the behaviour of users of the portal application;
determining usage patterns of the users, wherein a function of the set of functions is adapted to return parameter values according to the usage pattern of a user, wherein the user is one of the users, wherein the user is currently using the portal application.

5. The method of claim 1, further comprising:
providing an external service (308) outside of the portal application;
using a function (322) of the set of functions as point of variability in the meta-data, the function being used to link an application component of the application components with the external service.

6. The method of claim 5, wherein the external service (308) relates to a service component architecture (SCA) component, wherein the second function provides an interface to the SCA component.

7. The method according to claim 5, wherein the function is associated with a service discovery mechanism (324), wherein the service discovery mechanism is adapted to discover the external service during runtime of the portal application.

8. The method according to claim 1, wherein the functions of the set of functions (124, 130; 322, 328) are script-based or based on a programming language.

9. The method according to claim 1, wherein the application assembly descriptor (112, 312) is an XML file or wherein at least the meta-data (120, 126,128) in the application assembly descriptor is specified in XML.

10. A computer program product (122) comprising a computer usable medium including computer usable program code, wherein the computer program product is adapted to deploy a composite portal application (102), wherein the composite portal application comprises application components (114, 116, 118) in machine readable code for forming the portal application, an application assembly descriptor (112) in machine-readable code, wherein a set of functions (124, 130) is further provided, wherein the application assembly descriptor comprises meta-data (120, 126, 128), the computer usable program code being adapted to:
employ the meta-data to assemble the application components in order to provide the composite portal application on the portal server application environment;
evaluate a function of the set of functions when the function is employed as point of variability in the meta-data.

11. The computer program product of claim 10, wherein an external reference is used to reflect a function of the set of functions in the meta-data, wherein the computer usable program code comprises a parameter management logic, wherein the computer usable program code is further adapted to employ the parameter management logic to determine the function via the external reference during runtime of the portal application.

12. The computer program product of claim 10, wherein the computer usable program code comprises an agent, wherein the computer usable program code is further adapted to:
use the agent to monitor the behaviour of users of the portal application;
determine usage patterns of the users, wherein a function of the set of functions is adapted to return parameter values according to the usage pattern of the actual user of the portal application in case the actual user is one of the users.

13. The computer program product of claim 10, wherein the computer usable program code is further adapted to:
execute an external service (308);
employ a function (322) of the set of functions as point of variability in the meta-data, wherein the function is used to link an application component of the portal application with the external service.

14. Portal server application environment (122), wherein the portal server application environment is adapted for deploying a composite portal application (102), the composite portal application including application components (114, 116, 118) in machine readable code for forming the portal application, an application assembly descriptor (112) in machine-readable code, the application assembly descriptor comprising meta-data (120, 126, 128), the portal server application environment comprising:
means for employing the meta-data to assemble the application components for the provision of the composite portal application on the portal server application environment;
means for evaluating a function of a set of functions (124, 130), when the function of the set of functions is employed as point of variability in the meta-data.

15. The portal server application environment of claim 14, wherein an external reference (406) is used to reflect a function of the set of functions in the meta-data, wherein the portal server application environment comprises means for employing a parameter management logic to determine the function via the external reference during runtime of the portal application, wherein the parameter management logic is provided with the application assembly descriptor.

16. The portal server application environment of claim 14, further comprising:
means for using an agent to monitor the behaviour of users of the portal application;
means for determining usage patterns of users of the portal application, wherein a function of the set of functions is adapted to return parameter values according to the usage pattern of the actual user of the portal application in case the actual user is one of the users.

17. The portal server application environment of claim 14, further comprising means for using a function (322) of the set of functions as point of variability in the meta-data, the function being used to link an application component of the portal application with an external service (308), the external service being external to the portal server application environment.

18. A data processing system (100, 300), the data processing system being adapted to host a portal server application environment adapted for deploying a composite portal application (102), the composite portal application including application components (114, 116, 118) in machine readable code for forming the portal application an application assembly descriptor (112) in machine-readable code, the application assembly descriptor comprising meta-data (120, 126, 128), the portal server application environment comprising:
means for employing the meta-data to assemble the application components for the provision of the composite portal application on the portal server application environment;
means for evaluating a function of a set of functions (124, 130), when the function of the set of functions is employed as point of variability in the meta-data.

19. The data processing system of claim 18, the data processing system being adapted to host the external service linked via a function of the set of functions to the application component.

20. Portal server application environment (122), wherein the portal server application environment is adapted for deploying a composite portal application (102), the composite portal application including application components (114, 116, 118) in machine readable code for forming the portal application, an application assembly descriptor (112) in machine-readable code, the application assembly descriptor comprising meta-data (120, 126, 128), the portal server application environment comprising:
a component for employing the meta-data to assemble the application components for the provision of the composite portal application on the portal server application environment;
a component for evaluating a function of a set of functions (124, 130), when the function of the set of functions is employed as point of variability in the meta-data.
